(19) United States
(12) Patent Application Publication
(10) Pub. No.: US 2009/0232340 A1
(43) Pub. Date: Sep. 17, 2009

(54) EARPHONE STRUCTURE CAPABLE OF ADJUSTING VENTILATION OF CHAMBER THEREIN

(75) Inventor: Bill Yang, Taipei (TW)

Correspondence Address: J C PATENTS, INC., 4 VENTURE, SUITE 250, IRVINE, CA, 92618, US

(73) Assignee: Cotron Corporation, Taipei City (TW)

(21) Appl. No.: 12/129,276

(22) Filed: May 29, 2008

(30) Foreign Application Priority Data
Mar. 14, 2008 (TW) 97109137

(51) Int. Cl. H04R 5/033

(52) U.S. Cl. 381/371

(57) ABSTRACT

An earphone structure which allows adjusting ventilation of a chamber inside is provided. A plurality of holes is formed on a main body of the earphone structure and ventilation materials are disposed on the ventilation holes as a ventilation medium between the chamber in the main body and an external environment. A sound field generated in the chamber is changed through the change of the materials, which makes the sound field close to the natural tone. The adjustment of the ventilation is mainly based on the fact that sound has different frequency response effects on different materials in the transmission environment, thus achieving the effect of changing the sound field. For example, the adjustment of the ventilation can be achieved by filling different materials in the chamber. Further, partition part of the chamber can also use the frequency response of the sound of materials with different hardness.

### CROSS-REFERENCE TO RELATED APPLICATION

This application claims the priority benefit of Taiwan application serial no. 97109137, filed on Mar. 14, 2008. The entirety of the above-mentioned patent application is hereby incorporated by reference herein and made a part of specification.

### BACKGROUND OF THE INVENTION

1. Field of the Invention

The present invention generally relates to an earphone structure, in particular, to an earphone structure capable of adjusting ventilation of a chamber therein.

2. Description of Related Art

Along with the progress of digital technology, people's life and entertainment are gradually digitalized. For example, digital video disc (DVD) player is already a common image playing device in families. The DVD player basically has Dolby digital or digital theatre system (DTS) decoding function, and thus can decode digital signals read from the DVD and output analogue signals to speakers for generating corresponding sound.

If it intends to enjoy the digital video entertainment with higher quality, multi-channel speaker is an indispensable device, and 5.1 channels speaker is the most basic multi-channel speaker. Usually, in the family theatre with the 5.1 channels speaker, when a DVD player 100 plays the video, different sound signals are output to left and right speakers of front main channel, center channel speaker, left and right speakers of surround channel, and super bass speaker, so as to generate a three-dimensional sound effect enabling people to feel realistic.

However, under a situation that it is not appropriate to play the sound by the speakers (for example it may disturb other people), the earphone must be used for listening. For a common earphone, the speakers are disposed on left and right sides, and usually have a limited stereo effect, so the user cannot enjoy the multi-channel sound effect output by the DVD player.

Therefore, in the conventional art, an earphone having a plurality of speakers inside is provided, as shown in FIG. 1. A front main channel speaker 102, a center channel speaker 104, and a surround channel speaker 106 are respectively disposed on the left and the right sides of an earphone 100. A plug 108 with a special design is further provided, such that the DVD player can output the sound signals of different channels to different speakers through the plug 108, thereby generating the effect as that of the 5.1 channels speaker in the family theater as shown in FIG. 1. In the conventional earphone 100, the delay of the output sound signal is controlled through a circuit design, thus the output sound field is much poor than the effect of the 5.1 channels speaker disposed in the family theater with the large space, and it is impossible to achieve the quality and the efficacy of the multi-channel surround sound effect.

In the conventional earphone having a plurality of speakers, the distances of various space are simulated through delay and echo circuits by using the electronic circuit, and thus the presented tone is not so natural and realistic as the tone presented by the natural space. It is one of the topics in the field how to create a sense of spatial distance in the multi-channel earphone, for example 5.1 channels earphone, so as to improve the quality and the efficacy of the multi-channel surround sound field.

### SUMMARY OF THE INVENTION

The present invention is directed to a design capable of adjusting the ventilation of a chamber, such that a generated sound field is changed through the change of materials in the chamber, so as to make the sound field close to the natural tone. The adjustment of the ventilation is mainly based on the fact that sound has different frequency response effects on different materials in the transmission environment, thus achieving the effect of changing the sound field. For example, the adjustment of the ventilation can be achieved by filling different materials in the chamber. Further, partition part of the chamber can also use the frequency response of the sound of materials with different hardness.

In an embodiment, the earphone structure provided by the present invention includes an earphone main body, a plurality of speaker units, an outer annular structure, and a sound absorbing layer. The earphone main body has an annular part and a partition board, the annular part has a plurality of first ventilation holes, and an inner chamber is formed between the annular part and the partition board. Further, the plurality of speaker units is disposed in the inner chamber, so as to form a resonance space. The outer annular structure can be rotatably fixed on the annular part of the main body of the earphone main body, and has a plurality of second ventilation holes. The sound absorbing layer is disposed between the outer annular structure and the annular part. When the outer annular structure is rotated to make the first ventilation hole align with the second ventilation hole, the inner chamber ventilates to the external through the sound absorbing layer, such that the sound field generated by the earphone structure in the inner chamber release a part of sound pressure through the sound absorbing layer release, and generate frequency response corresponding to the material of the sound absorbing layer.

In an embodiment, the earphone structure provided by the present invention includes an earphone main body, a plurality of speaker units, an extending chamber tube, an outer annular structure, and a sound absorbing layer. The earphone main body has an annular part and a partition board, the annular part has a plurality of first ventilation holes, and an inner chamber is formed between the annular part and the partition board. The speaker units are disposed in the inner chamber, so as to form a resonance space. At least one extending chamber tube is disposed on the annular part and extending towards external of the main body, and at least a plurality of speaker units is respectively disposed in the extending chamber tube. The outer annular structure can be rotatably fixed on the annular part of the main body of the earphone main body, and has a plurality of ventilation holes. The sound absorbing layer is disposed between the outer annular structure and the annular part. The outer annular structure is rotated to make the ventilation hole align with another ventilation hole, the inner chamber ventilates to the outside through the sound absorbing layer, such that the sound field generated by the earphone structure in the inner chamber release a part of the sound pressure through the sound absorbing layer release, and generate frequency response corresponding to the material of the sound absorbing layer.

In an embodiment, the earphone structure provided by the present invention includes an earphone main body, a plurality of speaker units, a composite sound chamber, an outer annular structure, and a sound absorbing layer. The earphone main body has an annular part and a partition board, the annular part has a plurality of first ventilation holes, and an inner chamber is formed between the annular part and the partition board. At least one speaker unit is disposed on the partition board, so as to form a resonance space with the inner chamber. The composite sound chamber is disposed in the main body of the earphone and extends towards the external of the main body of the earphone, and at least a plurality of speaker units is respectively disposed in the composite sound chamber. The outer annular structure can be rotatably fixed on the annular part of the main body of the earphone main body, and has a plurality of second ventilation holes. The sound absorbing layer is disposed between the outer annular structure and the annular part. When the outer annular structure is rotated to make each first ventilation hole align with each second ventilation hole, the inner chamber ventilates to the external through the sound absorbing layer, such that the sound field generated by the earphone structure in the inner chamber release a part of the sound pressure through the sound absorbing layer release, and generate frequency response corresponding to the material of the sound absorbing layer.

The composite sound chamber has a plurality of extending chambers, respectively extending towards the external of the main body of the earphone, the speaker units located in the composite sound chamber are respectively disposed in the extending chambers, and the extending chambers are retractable to adjust the resonance space in the extending chambers.

In order to the make aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of the earphone having a plurality of speakers in the conventional art.

FIGS. 2A to 2F are schematic views of a multi-channel earphone structure capable of adjusting ventilation of a chamber therein according to an embodiment of the present invention.

FIGS. 3A to 3C are schematic views of a multi-channel earphone structure capable of adjusting ventilation of a chamber therein according to another embodiment of the present invention.

FIGS. 3D to 3E are schematic views when the ventilation holes of the multi-channel earphone structure of FIGS. 3A to 3C are at the opening state or the closed state.

FIG. 4A is a schematic view of a multi-channel earphone structure capable of adjusting ventilation of a chamber therein according to further another embodiment of the present invention.

FIG. 4B is a schematic view of a multi-channel earphone structure capable of adjusting ventilation of a chamber therein according to still another embodiment of the present invention.

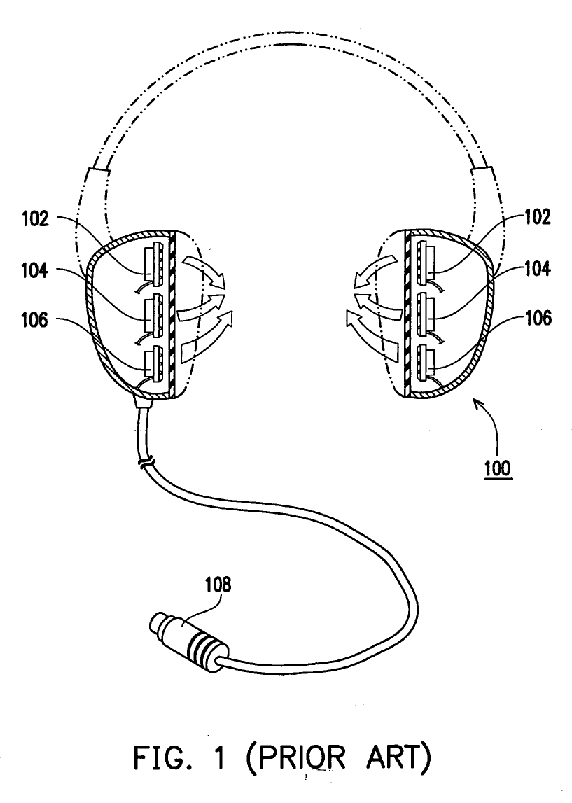

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The inventor of the present invention has conducted a series of optimal designs on the multi-channel earphone for creating the sense of spatial distance in the multi-channel earphone, for example the 5.1 channels earphone, so as to improve the quality and the efficacy of the multi-channel surround sound field. The characteristics of the earphone provided by the present invention, including, for example, the technique of improving the sound quality by adjusting the chamber designed in the earphone or the volume in the chamber, can be known with reference to ROC Application No. 93107621 filed on Mar. 22, 2004 and entitled “Earphone Structure with Composite Sound Field”, ROC Application No. 93111985 filed on Apr. 29, 2004 and entitled “Earphone Structure with Composite Sound Field”, ROC Application No. 94103553 filed on Feb. 4, 2005 and entitled “Multi-channel Earphone”, ROC Application No. 95105609 filed on Feb. 20, 2006 and entitled “Multi-channel Earphone”, or ROC Application No. 95130596 filed on Aug. 23, 2006 and entitled “Earphone with External Chamber Sound Guiding Tube”, or ROC Application No. 96205490 filed on Apr. 4, 2007 and entitled “Multi-channel Earphone and Structure thereof” (utility model No. M318871). The contents of the applications should be incorporated herein for reference and detailed descriptions are omitted.

In the applications, various different sound fields are presented by creating different physical space, for example the sound fields with different depths are generated by adjusting the distance between speaker units, or the sound field is divided by different inner chambers, or the sound field is extended by using the sound tube extending from the outer case, etc, so as to mix or divide the sound field through different physical space, thereby improving the quality and the efficacy of the multi-channel surround sound field.

The multi-channel earphone provided by the present invention has a design capable of adjusting ventilation of a chamber therein. A generated sound field is changed through the change of the materials in the chamber, which makes the sound field close to the natural tone. The adjustment of the ventilation is mainly based on the fact that sound has different frequency response effects on different materials in the transmission environment, thus achieving the effect of changing the sound field. For example, the adjustment of the ventilation can be achieved by filling different materials in the chamber. Further, partition part of the chamber can also use the frequency response of the sound of materials with different hardness.

For example, through the adjustment of the ventilation, the low frequency effect in the sound may be affected, so as to generate difference in sensing the space. For example, in the situation that the ventilation is better, the generated low frequency effect of the sound is sensed lighter, and the resulted delay effect is larger, such that the listener feels a larger space. In the condition that the ventilation is weaker, the generated low frequency effect of the sound is sensed heavier, and the resulted delay effect is smaller, such that the listener feels a smaller space. In the design, for the 5.1 channels sound source read from the DVD player, it is not necessary to generate the simulated sound effect, e.g., the delay effect, through the digital data processing.

In the following, the embodiments are used to illustrate the present invention. It should be noted that the following embodiments are used to illustrate the present invention instead of limiting the present invention.

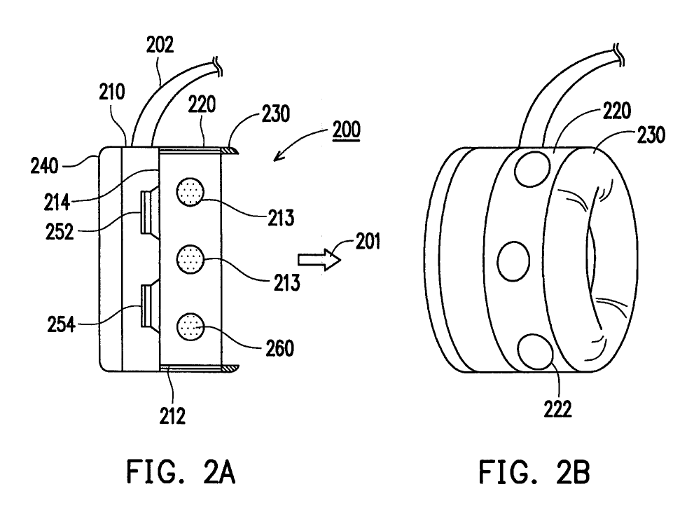

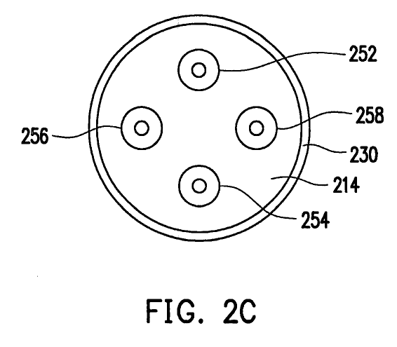

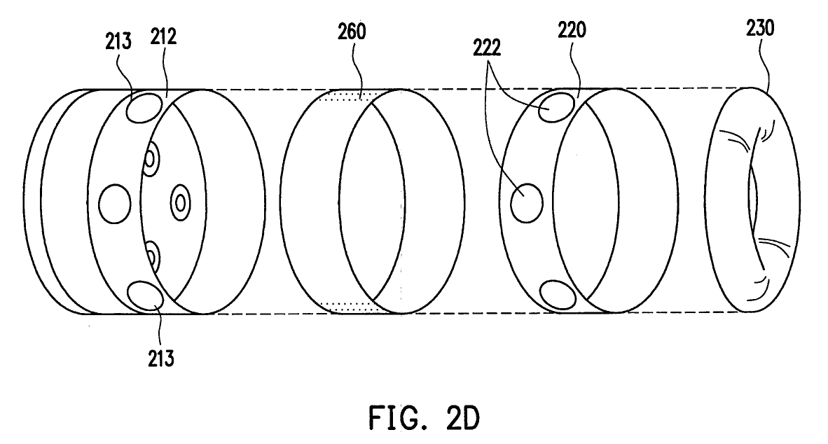

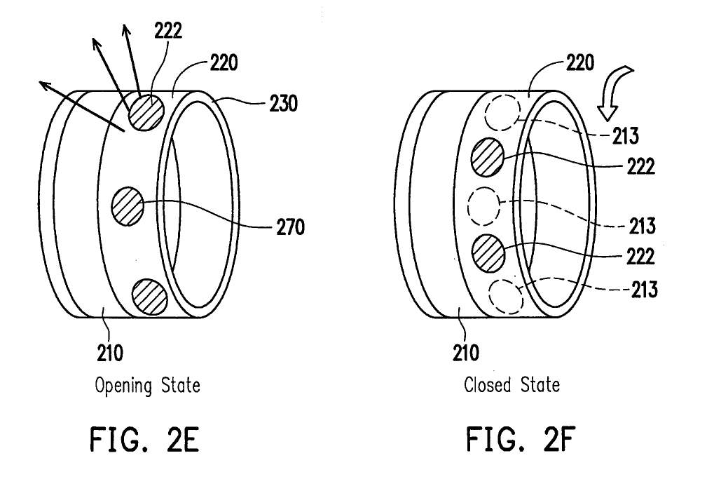

In this embodiment, referring to FIGS. 2A to 2D, a multi-channel earphone capable of adjusting ventilation of a chamber therein provided by the present invention is shown. FIG. 2A is a schematic cross-sectional view of a structure 200 of one of the left and right sides of the multi-channel earphone provided by the present invention, which is the same as the earphone structure of the other side, so it is not described repeatedly. The earphone structures 200 are connected to the sound source, e.g., the DVD player, respectively through a line 202. FIG. 2B is a schematic side view of the earphone structure 200, FIG. 2C is a schematic structural view of the earphone structure 200 from an ear direction 201 of a listener, and FIG. 2D is a schematic exploded view of the earphone structure 200.

In the following, the illustration of the earphone structure 200 refers to FIGS. 2B to 2D. The earphone structure 200 includes an earphone main body 210, an outer annular structure 220 having holes, an ear pad 230, an external chamber cover structure 240, and a plurality of speaker units 252-258. The earphone main body 210 has an annular part 212 and a partition board 214. The speaker units 252, 254, 256, and 258 are respectively disposed on the partition board 214.

The annular part 212 of the earphone main body 210 is rotatably embedded and fixed on the outer annular structure 220. The annular part 212 and the outer annular structure 220 respectively have a plurality of ventilation holes 213 and 222, when the outer annular structure 220 is rotated, the holes 213 and 222 are aligned with each other, so as to release the sound pressure in the earphone chamber. In order to adjust the ventilation to make the sound field in the chamber has different frequency responses on different materials in the transmission environment to achieve the effect of changing the sound field, a sound absorbing layer 260 is added between the annular part 212 and the outer annular structure 220, so as to serve as the medium of changing the sound field. The sound absorbing layer can be any material that is filled to affect the ventilation, for example, soft materials such as foam, non-woven fabric, ventilation paper, and tuning paper. Here, the sound absorbing paper is set as an example.

Referring to FIGS. 2E and 2F, schematic views of the earphone structure 200 when the ventilation holes are at the opening state and the closed state are shown. As shown in FIG. 2E, when the outer annular structure 220 is rotated, the ventilation holes 213 and 222 in the annular part 212 and the outer annular structure 220 of the earphone main body 210 are aligned with each other, the sound field generated in the earphone structure 200 can release a part of the pressure of the sound field through the ventilation holes 213 and 222, thus achieving the desired frequency response to change the sound field. In addition, as shown in FIG. 2F, if the outer annular structure 220 is further rotated, the ventilation holes 213 (as shown by the dashed line in the drawing) and 222 are not aligned with each other, such that the sound field generated in the earphone structure 200 does not release the pressure through the ventilation holes.

In the embodiment of the earphone structure 200, in the design capable of adjusting the ventilation of the chamber, a generated sound field is changed through the change of the materials in the chamber, which makes the sound field close to the natural tone. The adjustment of the ventilation is mainly based on the fact that the sound generates different frequency response effects on different transmission materials constructed in the chamber, thus achieving the effect of changing the sound field. Further, for partition part of the chamber, for example the inner chamber part, the materials with different hardness can be used to affect the frequency response of the sound.

For example, through design of different materials of the ventilation layer, the low frequency effect in the sound may be affected, so as to generate the difference in sensing the space. For example, in the situation that the ventilation is better, the generated low frequency effect of the sound is sensed lighter, and the resulted delay effect is larger, such that the listener feels a larger space. In the condition that the ventilation is weaker, the generated low frequency effect of the sound is sensed heavier, and the resulted delay effect is smaller, such that the listener feels a smaller space. In the design, for the 5.1 channels sound source read from the DVD player, it is not necessary to generate the simulated sound effect, e.g., the delay effect or the echo effect, through the digital data processing.

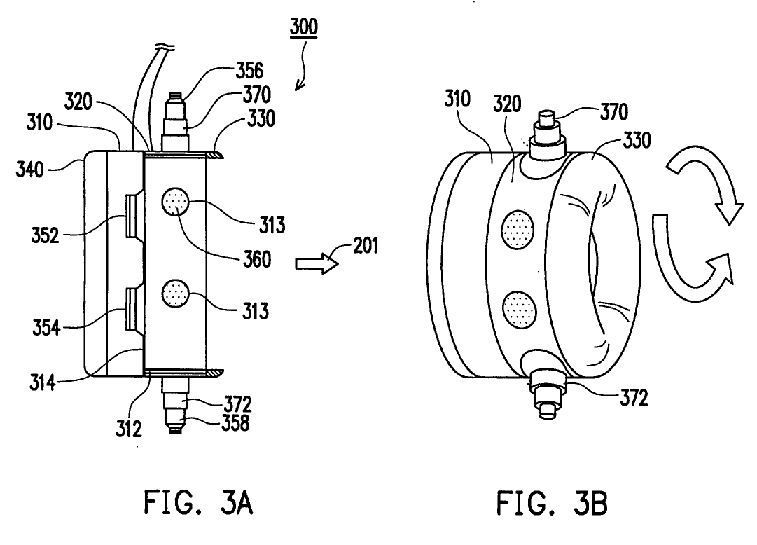

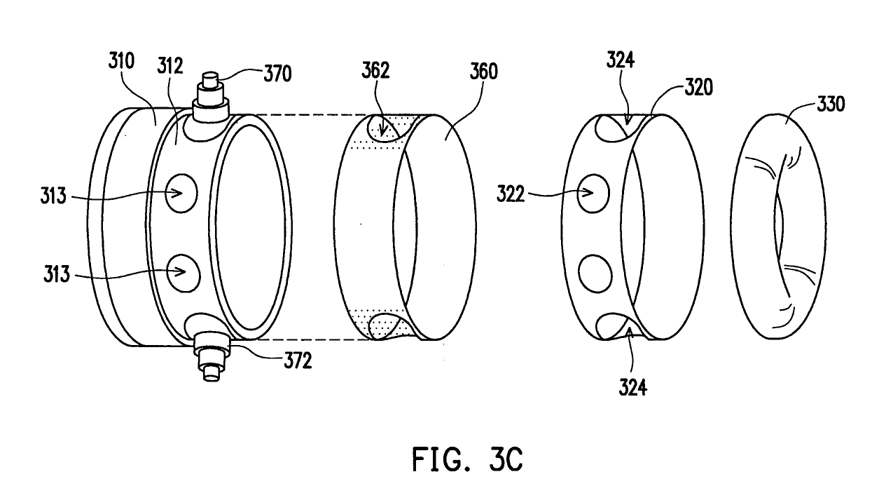

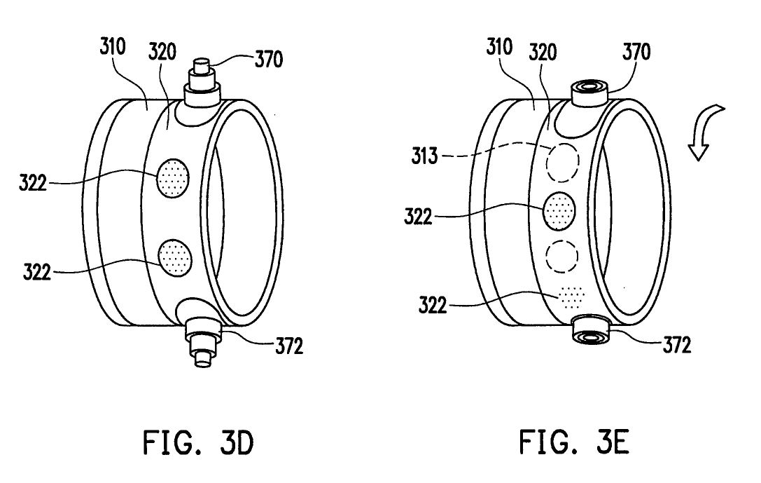

In another embodiment, referring to FIGS. 3A to 3D, a multi-channel earphone capable of adjusting ventilation of a chamber therein provided by the present invention is shown. FIG. 3A is a schematic cross-sectional view of a structure 300 of one of the left and the right sides of the multi-channel earphone provided by the present invention, which is the same as the earphone structure of the other side, so it is not described repeatedly. The earphone structures 300 are connected to the sound source, e.g., the DVD player, respectively through a line 302. FIG. 3B is a schematic side view of the earphone structure 300, and FIG. 2C is a schematic exploded view of the earphone structure 300.

The structure of the earphone structure 300, similar to the structure of the earphone structure 200 of FIG. 2A, includes an earphone main body 310, an outer annular structure 320 having holes, an ear pad 330, an external chamber cover structure 340, and a plurality of speaker units 352 and 354. The earphone main body 310 has an annular part 312 and a partition board 314. The speaker units 352 and 354 are respectively disposed on the partition board 314.

The structure of the earphone structure 300 is similar to the structure of the earphone structure 200 of FIG. 2A, so the same parts are not described repeatedly. The difference between the structure of the earphone structure 300 and the structure of the earphone structure 200 of FIG. 2A is that two extensible extending chamber tubes 370 and 372 are disposed on external side of the annular part 312, for controlling the depth of the extending sound field, so as to achieve different effects. Loud-speakers 356 and 358 are respectively disposed in the extending chamber tubes 370 and 372. Loud-speakers 352, 354, 356, and 358 are middle, surround, super bass, and other speakers required by the multi-channel sounder, and can be connected to the sound source of, for example, the 5.1 channel. In this embodiment, the loud-speakers 352 and 354 can be super bass or the main speaker, and the loud-speakers 356 and 358 can be the middle speaker and the surround speaker.

The annular part 312 of the earphone main body 310 is rotatably embedded and fixed on the outer annular structure 220. The annular part 312 and the outer annular structure 320 respectively have a plurality of ventilation holes 313 and 322, when the outer annular structure 320 is rotated, the holes 313 and 322 are aligned with each other, so as to release the sound pressure in the earphone chamber. A sound absorbing layer 360 is added between the annular part 312 and the outer annular structure 320, so as to serve as the medium of changing the sound field. The sound absorbing layer can be any material that is filled to affect the ventilation, for example, soft materials such as foam, non-woven fabric, ventilation paper, and tuning paper. Here the sound absorbing paper is set as an example. In addition, in order to prevent the extending chamber tubes 370 and 372 on the external side of the annular part 312 from affecting the rotation when the outer annular structure 320 is rotated, an elongated hole 324 is disposed on the annular part 312, and the sound absorbing layer 360 also has a corresponding elongated hole 362, such that when the outer annular structure 320 is rotated, the extending chamber tubes 370 and 372 are not affected.

Referring to FIGS. 3D and 3E, schematic views of the earphone structure 300 when the ventilation holes are at the opening state and the closed state are shown. As shown in FIG. 3D, when the outer annular structure 320 is rotated, the ventilation holes 313 and 322 in the annular part 312 and the outer annular structure 320 of the earphone main body 310 are aligned with each other, the sound field generated in the earphone structure 300 can release a part of the pressure of the sound field through the ventilation holes 213 and 222 via the sound absorbing layer 360 disposed therein, thereby achieving the desired frequency response to change the sound field. In order to achieve wider sound field and better frequency response, when the ventilation holes 313 and 322 are aligned with each other for ventilation, the extending chamber tubes 370 and 372 are in the state of extending outwards, thereby having deeper and wider sound field effect.

In addition, as shown in FIG. 3E, if the outer annular structure 320 is further rotated, the ventilation holes 313 and 322 are not aligned with each other, such that the sound field generated in the earphone structure 300 does not release the pressure through the ventilation holes. At this time, the extending chamber tubes 370 and 372 are retracted, and the chamber of the earphone structure 300 further has the low sound frequency response effect.

In the embodiment of the earphone structure 300, the design capable of adjusting the ventilation of the chamber utilizes the change of the materials in the chamber to change a generated sound field, which makes the sound field close to the natural tone. The adjustment of the ventilation is mainly based on the fact that the sound has different frequency response effects on different transmission materials constructed in the chamber, thus achieving the effect of changing the sound field. Further, for partition part of the chamber, for example the inner chamber part, the materials with different hardness can be used to affect the frequency response of the sound. In addition, the newly added extending chamber tubes 370 and 372 can deepen and widen the sound field generated in the earphone. In addition, the extending chamber tubes 370 and 372 can be extended or retracted according to the ventilation state adjustment, such that the whole multi-channel earphone can present more realistic sound.

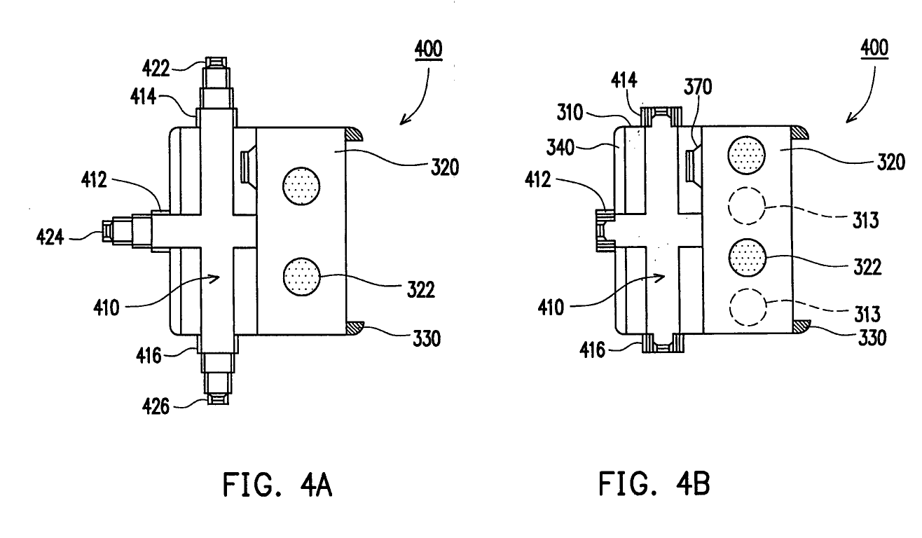

In further another embodiment, referring to FIGS. 4A and 4B, a multi-channel earphone capable of adjusting ventilation of a chamber therein provided by the present invention is shown. The earphone structure 400A is similar to the earphone structure 300 of FIGS. 3A to 3C, so the same elements are marked with the same reference numerals, and are not described repeatedly. The difference between the earphone structure 400 and the earphone structure 300 is that a composite sound chamber is formed in the chamber of the earphone structure 400, the composite sound chamber is formed by a plurality of extending chamber tubes and has a plurality of loud-speakers, thereby forming sound fields in the extending chamber tubes, and outputting the sound fields to form a composite sound field with the main sound field generated in the earphone structure. For example a chamber tube 410 is added to the structure of the composite sound chamber, and a plurality of loud-speakers, e.g., 422, 424, and 426 in the drawing, is selectively added to the extending chamber tubes 412, 414, and 416 on the end. The structure can deepen and widen the sound field generated in the earphone, such that the whole multi-channel earphone can present more realistic sound.

In order to achieve wider sound field and better frequency response, when the ventilation holes 313 and 322 are aligned with each other for ventilation, the extending chamber tubes 412, 414 and 416 are extending outwards, thereby having deeper and wider sound field effect. In addition, as shown in FIG. 4B, if the outer annular structure 320 is further rotated, the ventilation holes 313 and 322 are not aligned with each other, such that the sound field generated in the earphone structure 400 does not release the pressure through the ventilation holes. At this time, the extending chamber tubes 412, 414, and 416 are in a retracted state, and the chamber of the earphone structure 400 further has the low sound frequency response effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An earphone structure capable of adjusting ventilation of a chamber therein, the earphone structure comprising:
an earphone main body, comprising an annular part and a partition board, wherein the annular part comprises a plurality of first ventilation holes, and an inner chamber is formed between the annular part and the partition board;
at least one first speaker unit, disposed on the partition board, and forming a resonance space by using the inner chamber;
an outer annular structure, rotatably fixed on the annular part of the main body of the earphone, and comprising a plurality of second ventilation holes; and
a sound absorbing layer, disposed between the outer annular structure and the annular part, wherein the outer annular structure is rotated to make each first ventilation hole align with each second ventilation hole, the inner chamber ventilates to the outside through the sound absorbing layer, such that the sound filed generated by the earphone structure in the inner chamber releases a part of sound pressure through the sound absorbing layer, and generate frequency response corresponding to the material of the sound absorbing layer.

2. The earphone structure according to claim 1, wherein the sound absorbing layer is one selected from among foam, non-woven fabric, ventilation paper, and tuning paper.

3. The earphone structure according to claim 1, further comprising a plurality of extensible extending chamber tubes, fixed on the annular part of the main body of the earphone.

4. The earphone structure according to claim 3, further comprising a plurality of second speaker units, respectively disposed in the extensible extending chamber tubes.

5. An earphone structure capable of adjusting ventilation of a chamber therein, the earphone structure comprising:
an earphone main body, comprising an annular part and a partition board, wherein the annular part comprises a plurality of first ventilation holes, and an inner chamber is formed between the annular part and the partition board;
at least one first speaker unit, disposed on the partition board, and forming a resonance space by using the inner chamber;
a first extending chamber tube, disposed on the partition board, and extending towards external of the main body, wherein at least a plurality of second speaker units is respectively disposed in the first extending chamber tube;
an outer annular structure, rotatably fixed on the annular part of the main body of the earphone, and comprising a plurality of second ventilation holes; and
a sound absorbing layer, disposed between the outer annular structure and the annular part, wherein the outer annular structure is rotated to make each first ventilation hole align with each second ventilation hole, the inner chamber ventilates to the outside through the sound absorbing layer, such that the sound filed generated by the earphone structure in the inner chamber release a part of sound pressure through the sound absorbing layer, and generate frequency response corresponding to the material of the sound absorbing layer.

6. The earphone structure according to claim 5, wherein the sound absorbing layer is one selected from among foam, non-woven fabric, ventilation paper, and tuning paper.

7. The earphone structure according to claim 5, further comprising a plurality of extensible second extending chamber tubes, fixed on the annular part of the main body of the earphone.

8. The earphone structure according to claim 7, further comprising a plurality of third speaker units, respectively disposed in the second extending chamber tubes.

9. An earphone structure capable of adjusting ventilation of a chamber therein, the earphone structure comprising:
an earphone main body, comprising an annular part and a partition board, wherein the annular part comprises a plurality of first ventilation holes, and an inner chamber is formed between the annular part and the partition board;
at least one first speaker unit, disposed on the partition board, and forming a resonance space by using the inner chamber;
a composite sound chamber, disposed in the main body of the earphone, and extending towards external of the main body, wherein at least a plurality of second speaker units is respectively disposed in the composite sound chamber;
an outer annular structure, rotatably fixed on the annular part of the main body of the earphone, and comprising a plurality of second ventilation holes; and
a sound absorbing layer, disposed between the outer annular structure and the annular part, wherein the outer annular structure is rotated to make each first ventilation hole align with each second ventilation hole, the inner chamber ventilates to the outside through the sound absorbing layer, such that the sound filed generated by the earphone structure in the inner chamber release a part of sound pressure through the sound absorbing layer, and generate frequency response corresponding to the material of the sound absorbing layer.

10. The earphone structure according to claim 9, wherein the sound absorbing layer is one selected from among foam, non-woven fabric, ventilation paper, and tuning paper.

11. The earphone structure according to claim 9, further comprising a plurality of second extensible extending chamber tubes fixed on the annular part of the main body of the earphone, and a plurality of third speaker units respectively disposed on the extending chambers.

12. The earphone structure according to claim 9, wherein the composite sound chamber comprises a plurality of extending chambers, respectively extending towards external of the main body of the earphone, the second speaker units are respectively disposed in the extending chambers, and the extending chambers are retractable to adjust the resonance space in the extending chambers.
